(19) United States
(12) Patent Application Publication
(10) Pub. No.: US 2019/0346598 A1
(43) Pub. Date: Nov. 14, 2019

(54) IMAGING SYSTEMS AND METHODS WITH PERIODIC GRATINGS WITH HOMOLOGOUS PIXELS

(71) Applicant: Rambus Inc., Sunnyvale, CA (US)

(72) Inventors: Patrick R. Gill, Sunnyvale, CA (US); Alexander C. Schneider, Redmond, WA (US)

(21) Appl. No.: 16/475,849

(22) PCT Filed: Jan. 10, 2018
(86) PCT No.: PCT/US18/13150

§ 371 Date: Jul. 3, 2019

Related U.S. Application Data
(60) Provisional application No. 62/448,513, filed on Jan. 20, 2017.
(60) Provisional application No. 62/539,714, filed on Aug. 1, 2017.

(51) Int. Cl. G02B 5/18

(52) U.S. Cl. CPC G02B 5/1885; G02B 5/1842; G02B 5/1871; G02B 5/1823

(57) ABSTRACT

An imaging device has an optical grating with a repealing pattern of similar subgratings, each of which produces a similar interference pattern responsive to an image scene. An underlying pixel array samples the similar images to obtain a collection of similar, low-resolution patterns. A processor sums these patterns, on a per-pixel basis, to produce a low-noise, low-resolution digest of the imaged scene. The digest simplifies some aspects of image processing and has application where active illumination power is a chief concern, either for power constraints or when excessive illumination would be undesirable or unsafe.

### BACKGROUND

Optics can be thought of as performing mathematical operations transforming light intensities from different incident angles to locations on a two-dimensional image sensor. In the case of focusing optics, this transformation is the identity function: each angle is mapped to a distinct corresponding point on an image sensor. When focusing optics are impractical due to size, cost, or material constraints, the right diffractive optic can perform an operation other than the identity function that is nonetheless useful to produce a final image. In such cases the sensed data may bear little or no resemblance to the captured scene, but may nevertheless provide useful visual acuity to detect elements of interest in a monitored scene. A digital image can be computed from the sensed data if an application calls for image data that is sensible to human observers.

### BRIEF DESCRIPTION OF THE DRAWINGS

The detailed description is illustrated by way of example, and not by way of limitation, in the figures of the accompanying drawings and in which like reference numerals refer to similar elements and in which:

FIG. 1 depicts an imaging device 100 that employs a phase grating in lieu of a lens to dramatically reduce size and cost.

FIG. 2 shows imaging device 100 of FIG. 1 with the full tessellation of subgratings gi,j that make up optical grating 105.

FIG. 3 is a cut-away view of an infrared (IR) imaging device 300 similar to device 100 of FIGS. 1 and 2, with like-identified elements being the same or similar.

FIG. 4A depicts a sample image 400 of a fist adjacent a simulated output 405 from an imaging device (not shown) showing a two-by-two representation of the signals on a single subgrating array.

FIG. 4B depicts a sample image 410 of a pointed finger adjacent a simulated output 415 with the same two-by-two representation of the outputs of the array used to collect output 405 of FIG. 4A.

FIG. 5 is a cut-away view of an imaging device 500 similar to device 300 of FIG. 3, with like-identified elements being the same or similar.

FIG. 6A is a plan view of a portion of the light-collecting surface of an imaging device 600 in accordance with another embodiment.

FIG. 6B depicts a conventional photo 620 of a human eye adjacent raw intensity data 625 from a 2×2 array of gratings similar to what is illustrated in FIG. 6A.

FIG. 7 illustrates how an imaging device 700 in accordance with one embodiment uses polarized light to locate eyes for e.g. eye-tracking applications or focus detection.

FIG. 8 is a plan view of an image sensor 800 in accordance with an embodiment in which an array of subgratings 805 is angled with respect to an underlying sensor array 810 so that homologous pixels 815 are from different rows.

FIG. 9 is a plan view of an image sensor 900 in accordance with an embodiment with ten rows of ten subgratings 905, only one of which is shown so as not to obscure the underlying 50×60 pixel array 910.

### DETAILED DESCRIPTION

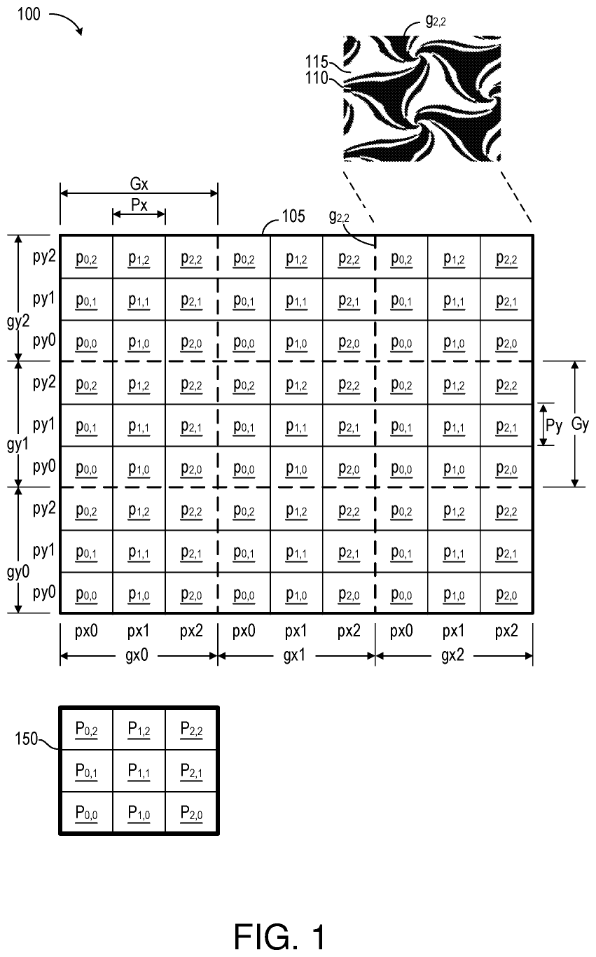

FIG. 1 depicts an imaging device 100 that employs a phase grating in lieu of a lens to dramatically reduce size and cost. Viewed from a perspective normal to the active surface, device 100 includes an optical grating 105 disposed over an array of pixels p_{i,j}, where i and j refer to locations along the respective X and Y axes. Grating 105 includes a pattern of periodic subgratings g_{i,j}, also called “tiles,” of which only subgrating g_{2.2} is shown in detail; the remaining subgratings g_{i,j} are identical in this example, and are highlighted using dashed boundaries to show their placement, orientation, and size relative to underlying pixels

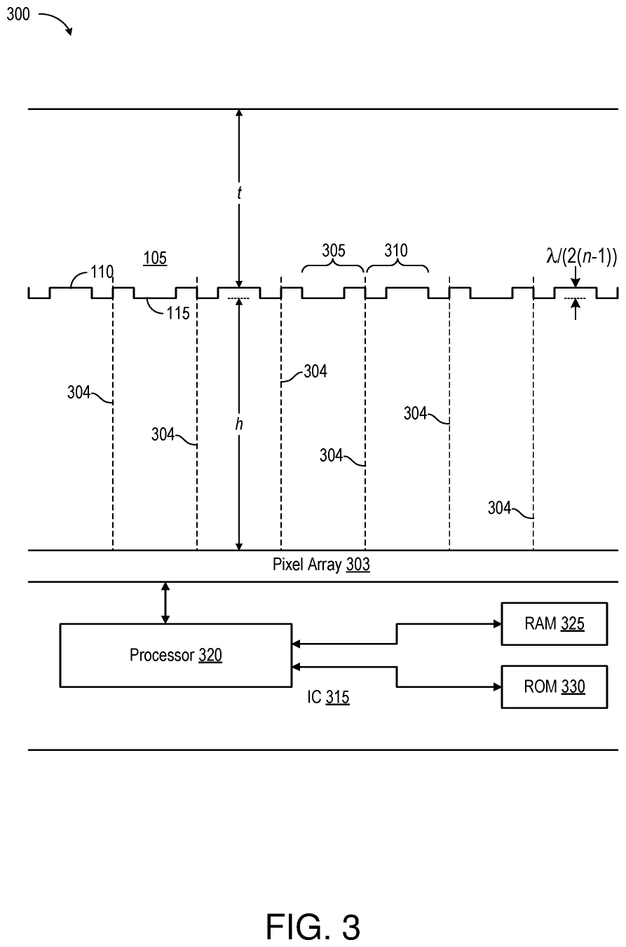

Each subgrating g_{i,j} produces a similar interference pattern for capture by the subset of nine underlying pixels p_{0,0} through p_{2,2}. As a result, the overall pixel array collectively samples nine similar nine-pixel patterns, each a relatively low-resolution representation of the same scene. A processor (FIG. 3) sums these patterns, on a per-pixel basis, accumulating an image digest 150 with nine intensity values P_{x,y}, one for each set of nine pixels p_{x,y}. Taking data from nine optically similar pixels improves the signal-to-noise ratio (SNR). Digest 150 thus represents a low-noise version of the accumulated image patterns. The reduced resolution of digest 150 relative to the native resolution of the pixel array simplifies some aspects of image processing, while the improved SNR is advantageous for low-light applications.

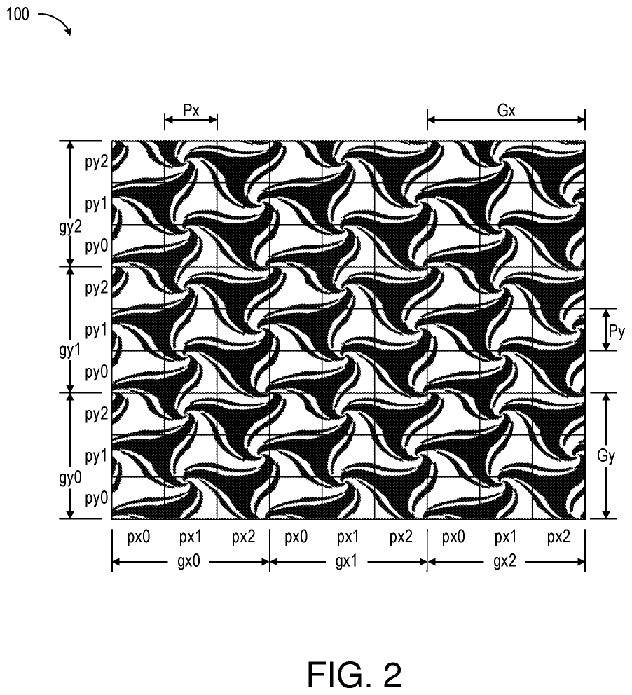

FIG. 2 shows imaging device 100 of FIG. 1 with the full tessellation of subgratings g_{i,j} that make up optical grating 105. The boundaries between subgratings g_{i,j} are contiguous across tessellation borders and so are not easily visible. Individual subgratings are nevertheless readily identifiable with reference to their Cartesian coordinates expressed along the X axis as gx[2:0] and along the Y axis as gy[2:0]. For example, subgrating g_{2,2} in the upper right corner is located in the intersection of column gx2 and row gy2. Pixels p_{i,j} are likewise identifiable for each corresponding subgrating along the X axis as px[2:0] and along the Y axis as py[2:0]. Pixels p_{i,j} are divisible into identical subarrays of nine (three-by-three) pixels p_{0,0} to p_{2,2}, with each subarray having pixels similarly positioned relative to an overlaying and respective one of the subgratings.

Imaging device 100 has a large effective aperture, as every point in an imaged scene illuminates the entire light-receiving surface of grating 105. Three-by-three arrays of subgratings, subarrays, and the digest are shown for ease of illustration. Practical embodiments may have many more pixels and subgratings, different ratios of pixels to subgratings, and different ratios of subgratings to subarrays. Some examples are detailed below.

Returning to FIG. 1, each pixel p_{i,j} in each nine-pixel subarray associated with a given subgrating g_{i,j} is homologous with a pixel p_{i,j} in each of the other subarrays in relation to their respective overlying subgratings g_{i,j}. Homologous pixels are identified in FIG. 1 as having the same subscript; for example, the nine pixels p_{0,0} are similarly positioned relative to their respective overlying subgratings g_{i,j} and are therefore homologous and optically equivalent. Intensity values sampled by each of nine sets of homologous pixels are accumulated into a digest 150, a low-resolution digital image that includes nine entries P_{x,y} each corresponding to an accumulation of intensity values from a group of nine homologous pixels p_{x,y}. Digest 150 thus represents a captured scene as an image with reduced noise and resolution relative to the native noise and resolution of a frame of pixel values captured by the overall array. Each accumulated intensity value P_{x,y} can be a sum or average of homologous-pixel values, or can be some other function of homologous-pixel values from one or more image frames.

There are only nine subgratings g_{i,j} and eighty-one pixels p_{x,y} in this simple illustration, but a practical embodiment can have e.g. hundreds or thousands of subgratings overlaying dense collections of pixels. An embodiment with 16×16 (256) subgratings over 1,024×1,024 (1M) pixels might produce a 4K (1M/256) pixel digest with much lower noise than apparent in the raw 1M pixel data, and that places a proportionally lower data burden on image processing and communication. In other embodiments the digest can correspond to more or fewer tiles, and the number of pixels per subgrating and digest can be different.

A low-power microcontroller or digital signal processor with a reasonable clock and very modest RAM (2 kB or so) can compute a digest alongside the pixel array, relaying the digest at a modest transfer rate over a lightweight protocol such as Serial Peripheral Interface (SPI) or Inter-integrated Circuit (I²C). An exemplary embodiment, not shown, includes a 54×30 array of subgratings over a full HD sensor (1920×1080 pixels) with a 2-micron pixel pitch. A digest pooled from all 1,620 (54×30) subarrays would yield a massive noise reduction and improved low-light sensitivity. If a higher framerate is needed, by exploiting a sensor with a rolling shutter to scan across the scene either vertically or horizontally, 54x spatial oversampling can be obtained at 30x temporal oversampling. Any intermediate scheme is also available, as are schemes with short-pulsed LEDs for portions of the rolling exposure, where multiple single-frame differential measurements are possible.

Subgratings g_{i,j} are periodic and identical in the preceding examples. Performance may be enhanced by warping the subgratings such that the point-spread functions (PSFs) from the different subgratings lack translation symmetry. Deliberately detuning the grating thickness can also lead to an asymmetry in the point source strengths, also breaking symmetry. In these cases, the warpings can themselves have a longer-scale periodicity, and the digest can reflect the diversity of signals over the largest optically relevant periodicity.

Phase gratings of the type used for subgratings g_{i,j} are detailed in U.S. Pat. No. 9,110,240 to Gill and Stork, which is incorporated herein by this reference. Briefly, and in connection with subgrating g_{2,2}, subgratings g_{i,j} are of a material that is transparent to IR light. The surface of subgratings g_{i,j} includes transparent features 110 (black) and 115 (white) that define between them boundaries of odd symmetry. Features 110 are raised in the Z dimension (normal to the view) relative to features 115, and are shown in black to elucidate this topography. As detailed below in connection with FIG. 3, the boundaries between features 110 and 115 produce an interference pattern on the underlying pixel array that contains rich spatial information about an imaged scene.

FIG. 3 is a cut-away view of an infrared (IR) imaging device 300 similar to device 100 of FIGS. 1 and 2, with like-identified elements being the same or similar. Grating 105 is a binary, odd-symmetry silicon phase grating of thickness t separated from a pixel array 303 by an air interface of height h. Silicon is a relatively inexpensive material that has high IR transmission, and it can be patterned using well-known semiconductor processes. Other materials are suitable, however, and can be selected for different wavelengths or for other material or cost considerations. In this embodiment, height h is 481 μm, thickness t is 800 μm, subgrating pitches Gx and Gy (FIG. 1) are each 70 μm, and pixel pitches Px and Py are each 2 μm. Each 70 μm² subgrating thus overlay a 35×35 pixel subarray of 2 um² pixels. Any or all of these parameters can vary. In an infrared embodiment, for example, subgrating pitches Gx and Gy might be 500 μm with pixel pitches of 25 μm, making for 20×20 pixel subarrays.

Adjacent features 110 and 115 form six illustrative odd-symmetry boundaries 304, each indicated using a vertical, dashed line. The lower features 115 induce phase retardations of half a wavelength (π radians) relative to upper features 110. Features 305 and 310 on either side of each boundary exhibit odd symmetry. The different phase delays produce curtains of destructive interference separated by relatively bright foci to produce an interference pattern on pixel array 303. Features 305 and 310 are of uniform width in this simple illustration, but vary across each subgrating g_{i,j} and collection of subgratings as shown, for example, in the example of FIGS. 1 and 2. Curved and divergent boundaries of odd symmetry provide rich patterns of spatial modulations that can be processed to extract photos and other image information from a scene.

Imaging device 300 includes an integrated circuit (IC) device 315 that supports image acquisition and processing. IC device 315 includes a processor 320, random-access memory (RAM) 325, and read-only memory (ROM) 330. ROM 330 can store a digital representation of the point-spread function (PSF) of subgratings g_{i,j}, possibly in combination with array 303, from which a noise-dependent deconvolution kernel may be computed. ROM 330 can also store the deconvolution kernel along with other parameters or lookup tables in support of image processing.

Processor 320 captures digital image data from the pixel array, accumulates the intensity values from homologous pixels into a digest (not shown), and uses the digest with the stored PSF or deconvolution kernel to e.g. compute images and extract other image data. In other embodiments the digest can be generated locally and conveyed to an external resource for processing. Processor 320 uses RAM 325 to read and write data, including e.g. digest 150 of FIG. 1, in support of image processing. Processor 320 may support specialized processing elements that aid fast, power-efficient Fourier- or spatial-domain deconvolution. Processor 320 and RAM 325 can be of a microcontroller, a small computer on a single integrated circuit with one or more processor cores, memory, and programmable input and output circuitry. The singular term “processor” refers to one or more processing elements that separately or together perform the sequences detailed herein.

A point source of light (not shown) far from imaging device 300 will produce nearly the same response on each subarray, with each response shifted about eight degrees horizontally or vertically for each successive subgrating. Array 303 captures raw intensity data, which is passed on a per-pixel basis to processor 320. Processor 320 computes a running sum of intensity values from each pixel in each homologous set of pixels. Computing a 35×35 pixel digest (70 um subarray pitch divided by the 2 um pixel pitch) of intensity values yields an extremely low-noise rendition of the light intensity for each pixel beneath a typical instance of a subgrating. Processor 320, possibly in combination with computational resources external to imaging device 300, can perform machine learning on the digest for e.g. pattern classification and gesture recognition.

Imaging device 300 may have defective pixels, either known a priori or deduced from their values that are incompatible with expectations. Processor 320 can be programmed to ignore defective pixels through simple logical tests, and at the application level one or two “spare” tiles can be physically made, their data used only in the event of encountering a bad pixel during the streaming of the data. Thus the same number of pixels may be used to generate each entry in a digest even if a few bad pixels are rejected.

Computational focusing (potentially at multiple depth planes simultaneously) can be achieved by keeping a digest of pixel data with a slightly larger array pitch than the optical tile. For example, a 36×36 digest of the scene generated by a 70×70 um subgrating would be sensitive to objects a little closer than infinity (22 mm in the case of the device in FIG. 3), a 37×37 digest is sensitive to objects yet slightly closer (11 mm), etc. Fractional effective pitches are also possible.

If an object at infinity would produce a signal with 35-pixel horizontal periodicity, accumulating with a (say) 36-pixel repetition over a block of sensor 1260 pixels wide (1260=35*36) should produce exactly no signal in expectation since each of the 36 elements of the digest gets precisely the same complement of contributions from the 35-pixel-wide true optical repetition. Any signal generated by this averaging comes from an object measurably closer than infinity, and statistically significant deviations from a uniform distribution indicate a nearby object. This type of sensing may be useful in range finding for e.g. drone soft landing.

The forgoing examples exhibit integer-valued pixel pitches. However, non-integer effective spatial pitches are also realizable by e.g. choosing to skip a pixel column every second tile (for half-integer expected repetitions), once or twice per block of pixels three tiles wide (for integer +⅓ and integer +⅔ expected periods), etc. Another approach is to use spatial interpolation to accommodate effective non-integer expected pixel shifts.

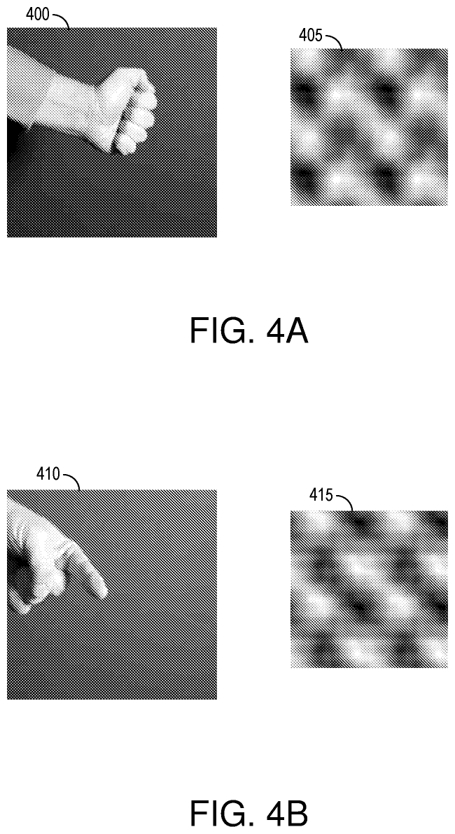

FIG. 4A depicts a sample image 400 of a fist adjacent a simulated output 405 from an imaging device (not shown) where a two-by-two representation is shown of the signals under a single subgrating array. FIG. 4B depicts a sample image 410 of a pointed finger adjacent a simulated two-by-two output 415 from the same subgrating array used to collect output 405 of FIG. 4A. Though outputs 405 and 410 are not recognizable as hands, they are sufficiently different from one another that machine learning algorithms can use them to distinguish a closed fist from a pointed finger. Other changes to hand position and configuration can likewise be distinguished. A deep neural network can distinguish fine changes in hand position and configuration for e.g. sensing hand gestures. An imaging device in accordance with one embodiment, for example, supports an “air mouse” that correlates pattern 415 with position and movement of the finger represented in image 410.

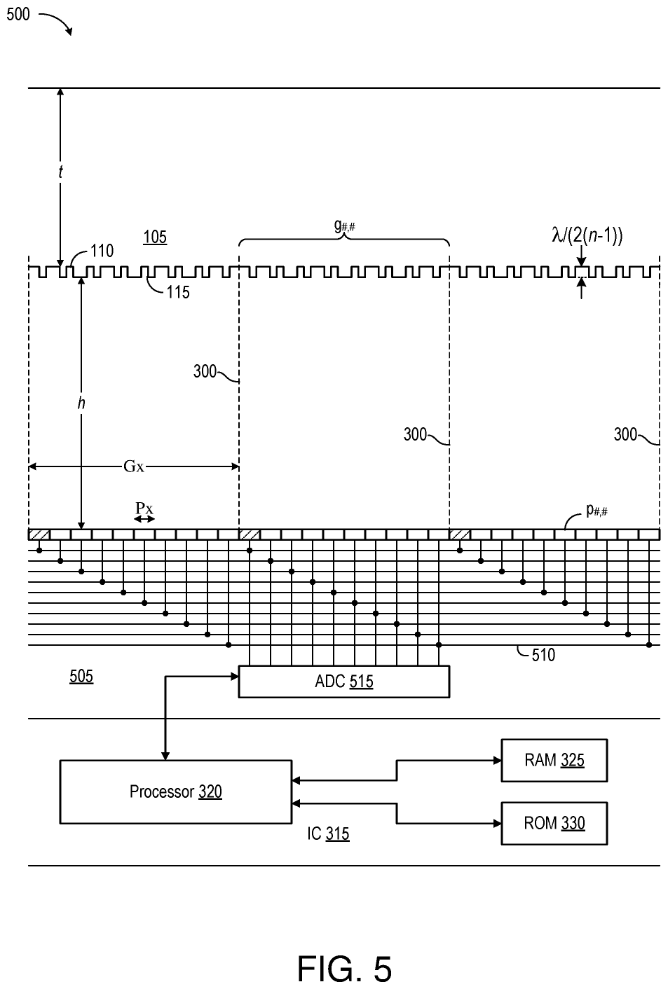

FIG. 5 is a cut-away view of an imaging device 500 similar to device 300 of FIG. 3, with like-identified elements being the same or similar. Imaging device 500 includes a sensor array 505 in which homologous pixels p_{i,j}, three of which are highlighted using cross hatching, are physically interconnected via conductive traces 510. Traces 510 directly interconnect homologous pixels among subgratings, and thus automatically combine the analog outputs from collections of homologous pixels to create an analog digest as input to an ADC converter 515. Processor 320 is thus relieved of the task of accumulating sample intensity values from homologous pixels. In other embodiments traces 510 can be replaced with a programmable interconnection matrix in which connectivity can be programmed to allow for different collections of homologous pixels.

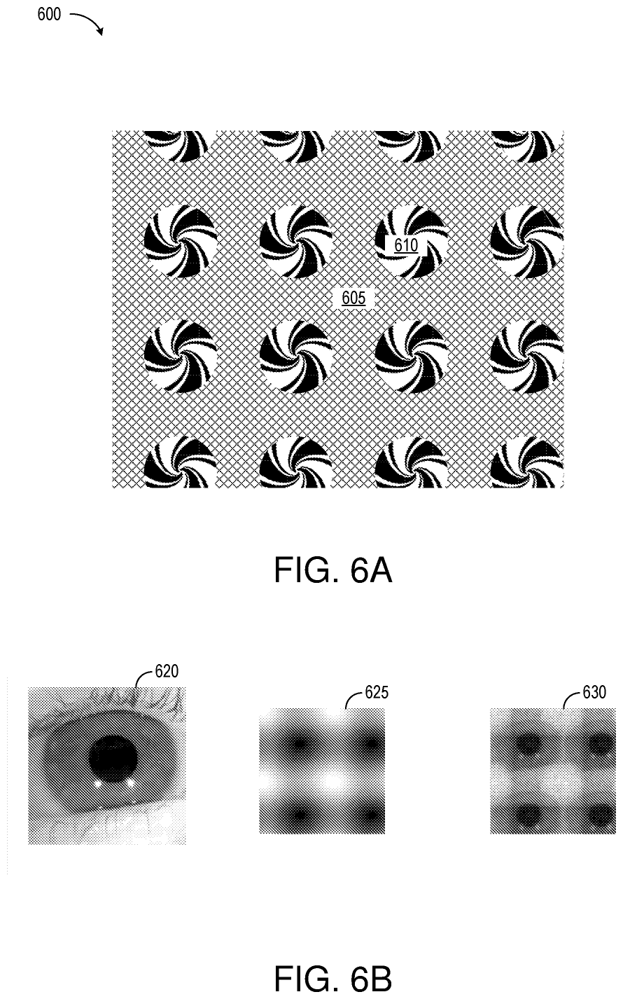

FIG. 6A is a plan view of a portion of the light-collecting surface of an imaging device 600 in accordance with another embodiment. Rather than contiguous subgratings, device 600 includes an opaque layer 605 with apertures through which discrete gratings 610 admit light to an underlying image sensor (not shown). The light-collecting surface admits about 30% of the incident light in this example. The effective optical height is 329 um, the aperture is 168 um, and the spatial period is 270 um. Two point sources separated horizontally or vertically by about 45 degrees produce equivalent signals. The array size over a 2 um pixel 1920×1080 image sensor is 14.2 by 8, so (for example) that sensor run at 30 Hz produces a 240 Hz stream of subarray signals that each have 14× averaging and has excellent light collection, whose data is describable in blocks of 135×135 pixels: roughly 8.7 MB/s (a reduction in data rate by a factor of 14.2 compared to the native data rate of the sensor). At 120 Hz, the data rate could be halved and averaging over e.g. 28 spiral gratings 610.

Imaging device 600 can be used to image proximate scenes, such as to track eye movement from the vantage point of a glasses frame. The large effective aperture is advantageous for this application because active illumination power is best minimized for power consumption and user safety. Excessive depth of field can pose a problem for eye tracking in such close proximity because eyelashes can obscure the view of the eye. The spatial pitch of imaging device 600 the separation of gratings 610 allows device 600 to exhibit depth sensitivity that can blur lashes relative to the eye. For example, given an eye relief distance of 22 mm, the pitch of repeated structures would be 135 pixels*22.329 mm/22 mm=137 pixels, not the 135 pixels of objects at infinity. Eyelashes on average 7 mm closer than the eye features have a pixel repetition pitch of 135 pixels*15.329/15=138 pixels, so averaging over 14 horizontal tiles blurs the effect of an eyelash horizontally by 14 pixels. This 14 pixel blur effectively blurs eyelashes by about 4.9 degrees, or 1.27 mm at a 15 mm standoff, which is about 4× more blur than an eyelash is thick. The optical effective distance of the glints or first Purkinje reflections of the light sources can be greater than the optical effective distance to the pupil features. Purkinje images may be best focused under the assumption of a 135.5 pixel repetition pitch. If it is desirable to form in-focus imaging of both glints and pupil features, special processing can compute separate subarray signals from a single data stream, one assuming a 137-pixel pitch and the other assuming a 135.5-pixel repetition pitch.

FIG. 6B depicts a conventional photo 620 of a human eye adjacent raw intensity data 625 from a 2×2 array of gratings similar to what is illustrated in FIG. 6A. This example omits the step of producing a digest, so inverting raw intensity data 625 provides a view 630 of four eyes, one for each grating. The lashes in source photo 620 are omitted from reconstructed view 630 but the pupil and reflections are plainly evident. Eye direction can be computed and tracked by sensing and comparing the positions of the centers of the pupil and reflected point sources. The point sources, such as IR LEDs that admit light outside the visible spectrum, are preferentially of low power due to supply constraints and safety concerns. Using a digest to improve the signal-to-noise ratio is therefore advantageous.

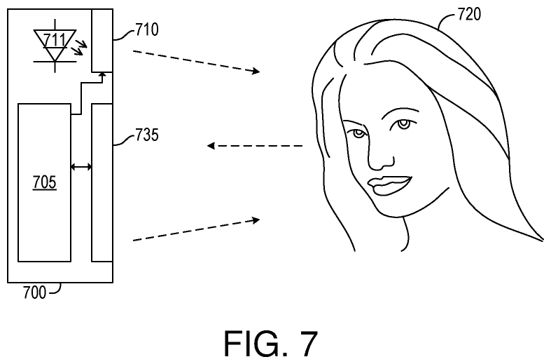

FIG. 7 illustrates how an imaging device 700 in accordance with one embodiment uses polarized light to locate eyes for e.g. eye-tracking applications or focus detection. A processor 705 controls a liquid-crystal shutter 710 to alternately polarize IR light from a light-emitting diode 711, and thus to illuminate the face of a person 720 using light of more than one polarization. An image sensor 735, which could be of a type detailed above, captures a sequence of images of the illuminated face. Processor 705 then compares frames or portions of frames illuminated by the different polarizations. Skin tends to randomize linear polarization. Eyes, being specular reflectors, reflect polarized light differently than skin. Processor 705 compares signals taken under different polarization conditions to find appropriately spaced specular reflectors in a diffuse-reflecting mass of approximately the right dimensions. This technique may be used to for low-power face or eye detection with the previously discussed embodiments such as, for example, those of FIGS. 2 and 3 and their accompanying description.

In some embodiments with multiple illumination conditions, the mean intensity of any one illumination condition is not per se useful; only the difference between illumination conditions is required by the application. In this case, to reduce the quantity of memory required, processor 705 can increment a digest under a first illumination condition and decrement it under a subsequent condition. More complicated schedules of incrementing or decrementing the digest 150 can also be desirable, for example to detect only the polarization-dependent reflectivity of a scene where some background light may also be polarized, a fixed-polarization illumination source such as a polarized LED could be used in conjunction with a liquid crystal over the sensor. Here, four conditions are relevant: LED on or off, in conjunction with aligned or cross polarization of the liquid crystal. One relevant signal could be the component of the reflected LED light that is polarization-dependent, calculated as the sum of the parallel polarization with the LED on and the crossed polarization with the LED off, minus the sum of the crossed polarization with the LED on and the parallel polarization with the LED off. This digest can be accumulated differentially as described above, requiring only one quarter of the memory that would be required if each digest were to be stored independently.

In some embodiments in which image sensor 735 includes gratings or tiles, processor 705 can pulse LED 711 such that some pixel rows are exposed for a full pulse, some for no pulse, and others get an intermediate pulse exposure. Throwing out intermediate rows, any one-tile-high collection of pixels with a desired exposure contains some permutation of all the data needed, even if the “top” of the logical canonical tile occurs somewhere in the middle of the rows of a certain desired illumination state. Shifting the address of the pixels accumulated recovers correct data in the canonical arrangement, wasting no rows of data. Processor 705, aware of the timing of frame capture, can ensure that various active illumination states occur at known locations within one frame.

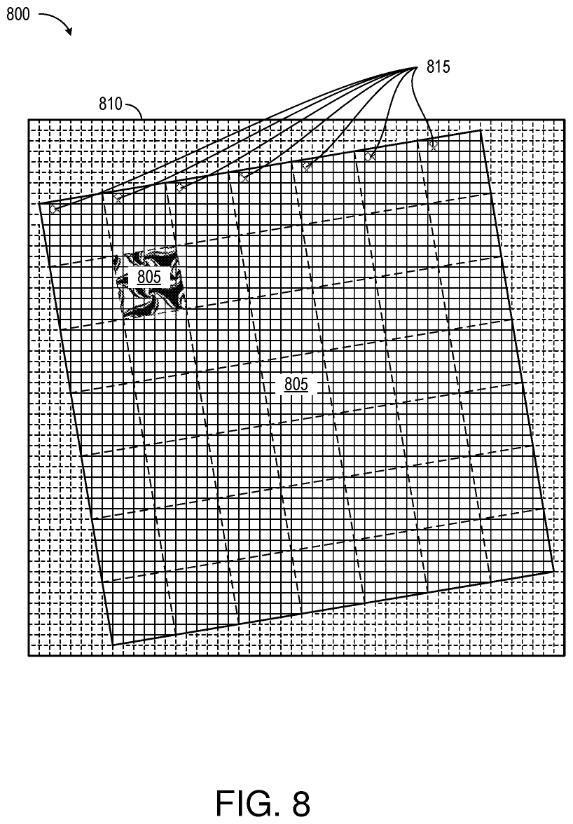

FIG. 8 is a plan view of an image sensor 800 in accordance with an embodiment in which an array of subgratings 805 is angled with respect to an underlying sensor array 810 so that homologous pixels 815 are from different rows. One common noise source in image sensors is additive noise applied to each row. Summing intensity values strictly across rows to accumulate values for a digest can thus accumulate row-specific noise. In this embodiment the array of subgratings 805 is rotated with respect to the pixel array such that each row of pixels contributes equally or approximately equally to each row in a digest of pixels. Row noise is thus largely cancelled.

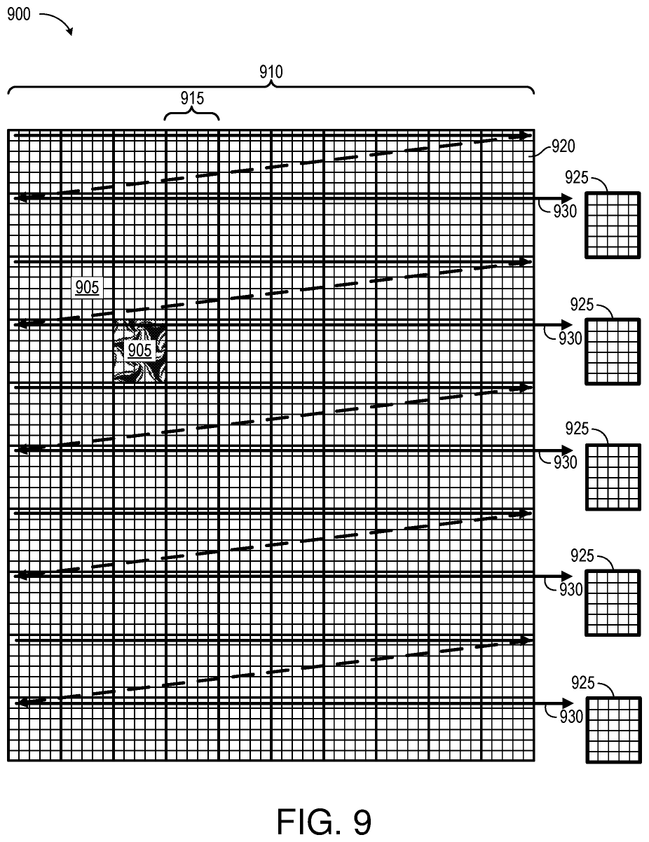

FIG. 9 is a plan view of an image sensor 900 in accordance with an embodiment with ten rows of ten subgratings 905, only one of which is shown so as not to obscure the underlying 50×60 pixel array 910. Each subgrating 905 overlies a 5×6 subarray 915 of pixels 920. The boundaries of subarrays 915 are illustrated using relatively dark lines that need not correspond to any structure.

Pixel array 910 uses an exposure process of a type commonly referred to as “rolling shutter” in which rows of pixels 920 are sequentially scanned. To capture a single frame, the pixels of the top row become photosensitive first and remain so over an exposure time. Each successive row becomes photosensitive a row time after the prior row, and likewise remains photosensitive over the exposure time. The time required to scan all rows, and thus acquire data from all pixels 920 in array 910, is referred to as a “frame time.” The speed with which frames can be delivered is referred to as the “frame rate.”

Sensor 900 exploits the rolling shutter to provide successive digests 925 at a digest rate greater than the frame rate. In this example, sensor 900 accumulates and issues a digest 925 for each two rows of subgratings 905, or twelve rows of pixels 920. The digest rate is thus five times the frame rate of pixel array 910 alone. Arrows 930 show how two rows of pixels 920 are accumulated into one five-element row of each digest 925. Row exposure times are normally longer than row times in rolling-shutter devices, and arrows 930 are not intended to limit the order in which pixels are read or their sample values accumulated. In other embodiments a digest can accumulate sample data bridging multiple full or partial frames. The size and aspect ratio of digest 925 may be different, and are adjustable in some embodiments.

Sensors in accordance with other embodiments can employ exposure processes other than rolling shutter. For example, sensors that scan an entire image simultaneously are referred to as “global shutter.” Some embodiments accumulate multiple digests from a global-shutter to measure spatial disparity for relatively nearby objects. For example, a 50×60 pixel global-shutter array can be divided into four 25×30 pixel quadrants, and each quadrant in turn divided into a 5×5 array of 5×6 pixel subarrays of homologous pixels under similar subgratings. Sample values from the twenty-five (5×5) subarrays in each quadrant can then be accumulated into a single 5×6 value digest to provide four laterally displaced images of the same scene. Objects close to the grating will appear offset from one another in the four digests, and these offsets can be used to calculate e.g. the position of the object relative to the sensor. As in the rolling-shutter embodiment, the number, size, and shape of digests can be different, and may be adjustable.

Pixel arrays can include superfluous pixel structures that are e.g. defective or redundant and not used for image capture. Such superfluous structures are not “pixels” as that term is used herein, as that term refers to elements that provide a measurement of illumination that is used for image acquisition. Redundant pixels can be used to take multiple measurements of pixels in equivalent positions, reducing noise.

While the subject matter has been described in connection with specific embodiments, other embodiments are also envisioned. For example, imaging devices that do not not employ apertures can be used in applications that selectively defocus aspects of a scene, and the wavelength band of interest can be broader or narrower than those of the foregoing examples, and may be discontinuous. A linear array of pixels can be used alone or in combination with other linear arrays to sense one-dimensional aspects of a scene from one or more orientations. Moreover, if a given subgrating exhibits some Fourier nulls, then two or more general regions that potentially have different aspect ratios, grating designs or orientations, or any combination of the above, could provide independent measurements of the scene. Other variations will be evident to those of skill in the art. Therefore, the spirit and scope of the appended claims should not be limited to the foregoing description. Only those claims specifically reciting “means for” or “step for” should be construed in the manner required under the sixth paragraph of 35 U.S.C. §112.

What I claimed is:

1. An imaging device comprising:
an optical grating including a repeating pattern of subgratings;
an array of pixels underlying the optical grating such that subarrays of the optical grating each have pixels positioned relative to an overlaying one of the repeating pattern of subgratings; and
a memory to store an array of intensity values for each of a collection of pixels, each intensity value being an accumulation of sample values of pixels from multiple subarrays.

2. The imaging device of claim 1, the pixels in each subarray positioned relative to an overlaying one of the subgratings, each pixel in each subarray homologous with a pixel in each of the other subarrays in relation to their respective overlying subgratings.

3. The imaging device of claim 2, wherein the accumulation of sample values from homologous pixels of the subarrays.

4. The imaging device of claim 1, wherein the array of intensity values includes one of the intensity values for each of the pixels in one of the subarrays.

5. The imaging device of claim 1, further comprising a processor coupled to the array of pixels and the memory to accumulate the intensity values.

6. The imaging device of claim 5, wherein the processor sums the sample values to accumulate the intensity values.

7. The imaging device of claim 5, wherein the array of pixels includes rows and columns of pixels, and wherein the processor accumulates the intensity values for a first row of the pixels before accumulating the intensity values for a second row of the pixels.

8. The imaging device of claim 1, the pixels in each subarray positioned relative to an overlaying one of the subgratings, each pixel in each subarray homologous with a pixel in each of the other subarrays in relation to their respective overlying subgratings, the imaging device further comprising a conductive path directly interconnecting one of the pixels in one of the subarrays with the homologous pixels in others of the subarrays.

9. The imaging device of claim 8, further comprising an analog-to-digital converter coupled to the conductive path to digitize a signal simultaneously collected by the homologous pixels.

10. The imaging device of claim 1, further comprising conductive paths, one conductive path directly interconnecting each set of homologous pixels.

11. The imaging device of claim 1, wherein the array of pixels comprises rows of pixels, and wherein homologous pixels are in different ones of the rows of pixels.

12. The imaging device of claim 1, wherein the subgratings are identical.

13. The imaging device of claim 1, the optical grating to cast an interference pattern on the array of pixels, each subgrating including boundaries of odd symmetry separating stepped features on opposite sides of each boundary, the stepped features on the opposite sides of each boundary to produce curtains of destructive interference at the pixel array.

14. The imaging device of claim 1, further comprising superfluous pixels.

15. The imaging device of claim 14, wherein the superfluous pixels comprise defective pixels.

16. A method comprising:
directing light from a scene through an array of subgratings, each subgrating producing an interference pattern from the light;
sampling the interference patterns with an array of pixels divisible into subarrays, each subarray having pixels positioned relative to an overlaying one of the subgratings to capture intensity values responsive to the light, each pixel in each subarray homologous with one of the pixels in each of the other subarrays in relation to their respective overlying subgratings; and
accumulating a set of intensity values for each set of the homologous pixels.

17. The method of claim 16, wherein the subarrays each include a number of pixels, and wherein the set of intensity values is of the number of pixels.

18. The method of claim 16, wherein the accumulating comprises, for each set of intensity data, summing the intensity values of the homologous pixels.

19. The method of claim 18, wherein the intensity values are analog outputs, and wherein the summing comprising conveying the analog outputs from the homologous pixels on common conductive traces.

20. The method of claim 16, wherein the array of pixels includes rows and columns of pixels, the method further comprising accumulating the intensity values for a first of the sets of homologous pixels before accumulating the intensity values for a second of the sets of homologous pixels.

21. The method of claim 16, wherein the array of pixels includes rows of pixels and columns of pixels, the method further comprising accumulating the intensity values for a first of the sets of homologous pixels from more than one of the rows of pixels.

22. The method of claim 21, wherein each of the homologous pixels in the first of the sets of homologous pixels is in a different one of the rows of pixels.

23. An imaging device comprising:
an optical grating including a repeating pattern of subgratings;
an array of pixels underlying the optical grating such that subarrays of the optical grating each have a subarray of pixels positioned relative to an overlaying one of the repeating pattern of subgratings, each subarray of pixels to sample an array of intensity values; and
means for calculating a digest of the intensity values from the subarrays of pixels.

24. The imaging device of claim 23, each pixel in each subarray of pixels positioned relative to an overlaying one of the subgratings to sample an intensity value responsive to light, each pixel in each subarray of pixels homologous with one of the pixels in each of the other subarrays in relation to their respective overlying subgratings.

25. The imaging device of claim 24, each wherein the means for calculating the digest accumulates the intensity values from each collection of homologous pixels.
